(19) United States
(12) Patent Application Publication
(10) Pub. No.: US 2022/0010150 A1
(43) Pub. Date: Jan. 13, 2022

(54) CORRECTION LIQUID

(71) Applicant: Youngran Choe, Seoul (KR)

(72) Inventor: Youngran Choe, Seoul (KR)

(21) Appl. No.: 16/921,953

(22) Filed: Jul. 7, 2020

(51) Int. Cl. C09D 10/00; C08K 3/22; C08G 73/02; C08L 83/04; C08L 27/06; C08L 33/08

(52) U.S. Cl. CPC C09D 10/00; C08K 3/22; C08G 73/028; C08K 2003/2241; C08L 27/06; C08L 33/08; C08L 83/04

(57) ABSTRACT

A removable hiding fluid includes an organic solvent; a dispersing and wetting agent having a polyamine amide of polycarboxylic acid; an opacifier at a content between 50% and 60% by weight relative to a total weight of the removable hiding fluid; a resin; and an additive including a rubber element melted into a mixture of the organic solvent, dispersing and wetting agent, specifier and resin.

### TECHNICAL FIELD

The present disclosure relates to a removable hiding paper.

### BACKGROUND

Correction fluid has been used to correct typewriting and/or handwriting mistakes. For example, when a typewriter makes a mistake on typing characters on a paper, he or she may past or apply a correction fluid to the portion where the mistake is made. Organic solvents contained in the correction fluid solidify over time with exposure to the air, and the mistake is covered by the pasted correction fluid. A correct typing may be made or written on top of the correction fluid after the correction fluid is solidified on a pater.

### SUMMARY

Provided is a removable hiding fluid that may be removed after being applied onto a paper. The removable hiding fluid includes titanium dioxide, which has a color index of pigment white, solvent naphtha, petroleum and light aliphatic, resin, mineral spirits, colorants, fragrance, and dispersant. In particular, the removable hiding fluid also includes a rubber element with the chemicals such that the hiding fluid may be removed after being solidified on a paper.

### BRIEF DESCRIPTION OF THE DRAWINGS

FIG. 1 is a view illustrating an application of a removable hiding fluid to a paper.

FIG. 2 is a view illustrating a removing process of the removable hiding fluid from the paper after the removal hiding fluid is dried to be solidified.

### DESCRIPTION OF EMBODIMENT

Hereinafter, an example of a removable hiding fluid according to the present disclosure will be described with reference to the accompanying drawings.

### Example 1

Correction fluid, correction pens, and correction tape have been used for many years helping people to easily hide a typing and/or writing mistakes. These products are applied to the portion where mistakes are made to cover the mistakes. However, these products may not be easily peeled off or removed once applied and solidified on the paper. Therefore, a covered portion by these products may not be recovered easily.

The removable hiding fluid of the present disclosure is specifically configured and provides a specific characteristic in which the removable hiding fluid is removed or peeled-off after the removable hiding fluid is applied and solidified on a paper or any other printing material such as a display screen.

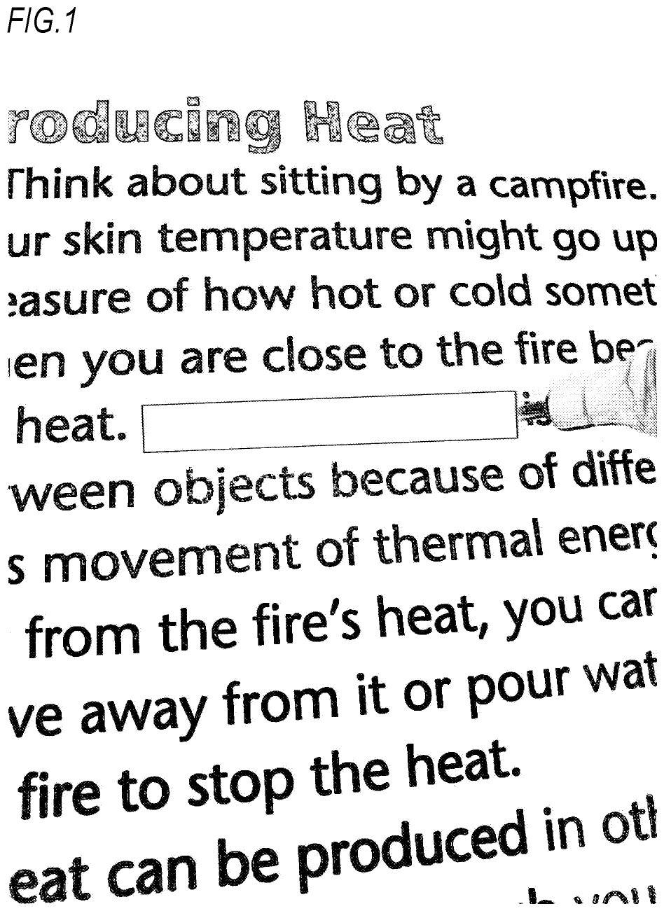

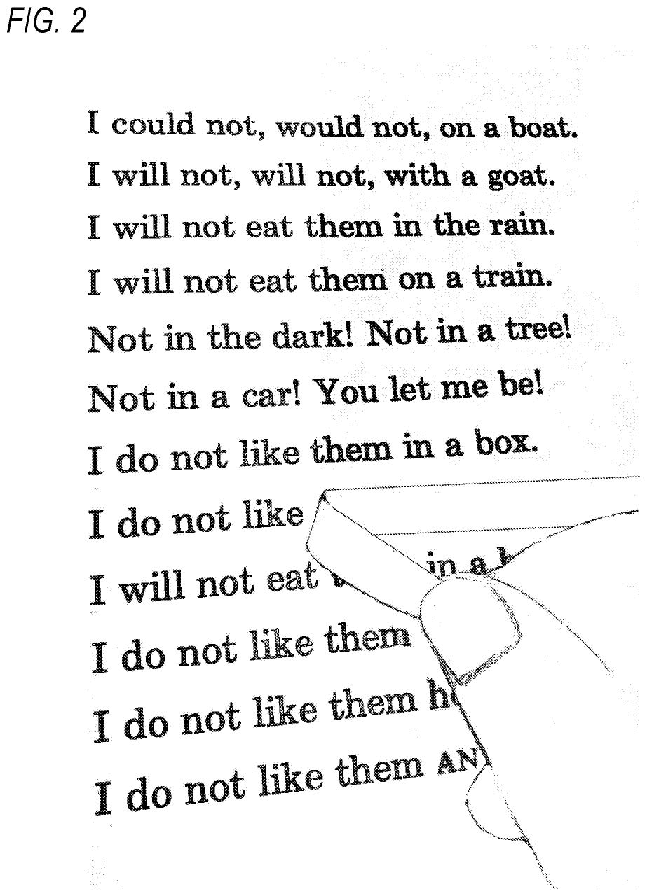

For the purposes of the present invention, “a removable hiding fluid” is intended to mean any white-colored opaque fluid that can be removable from a paper after being solidified. People sometimes want to cover or hide a portion of a book and remove the covered portion at a later time in order to recover and read the covered portion. For example, a student, while reading a book, may want to cover a portion of a book and apply the removable hiding fluid to the portion as illustrated in FIG. 1 so that the portion may be covered by the removable hiding fluid. Sometime after, when the student wants to read the portion covered by the removable hiding fluid, the student may peel off the removable hiding fluid solidified on the portion of the book so that the covered portion is recovered and the words underneath the removable hiding fluid may be read by the student, as illustrated in FIG. 2.

The user may use a hand to peel off the removable hiding fluid solidified on the paper as illustrated in FIG. 2, but the method of peeling off the removable hiding fluid may not be limited thereto. For example, a user may utilize a simple tool such as a pen to peel off the hiding fluid. Alternatively, the user may use a customized needle specifically designed to peel off the removable hiding fluid.

A removable hiding fluid of the first example of the present disclosure is made using an assortment of chemicals to create a fluid that spreads across a paper of the book. The first chemical is titanium dioxide, which has a color index of pigment white, the standard color for the correction fluid. Next are the solvent naphtha, petroleum and light aliphatic, which mix with the initial chemical. Resin, mineral spirits, colorants, fragrance, and dispersant also combine with the rest of the chemicals to create the opaque, white substance.

The removable hiding fluid of the present disclosure includes a rubber element in addition to the contents included in the conventional correction fluid. As an example, a silicone rubber having a content between 0.01% and 10% by weight relative to the total weight of the removable hiding fluid may be melted to be added to the chemicals of the conventional correction fluid such that the removable hiding fluid may have a characteristic of being peeled off after being solidified on a paper.

### Example 2

The removable hiding fluid of a second example of the present disclosure includes an organic solvent, a dispersing and wetting agent including a polyamine amide of polycarboxylic acid, an opacifier (e.g., TiO₂) at a content of between 40% and 60% by weight relative to the total weight of the removable hiding fluid, a resin, and an additive including the rubber element.

The removable hiding fluid of the second example contains an opacifier, such as a white pigment (in particular at a content before drying of between 37% and 60% by weight relative to the total weight of the removable hiding fluid before drying, and advantageously at a content after drying of between 50% and 90%, in particular of 75% by weight relative to the total weight of the removable hiding fluid after drying) having a viscosity of between 50 cPs and 150 cPs measured at 10° C. and at a shear rate of 100 s⁻¹ with the Anton Paar model MCR 301 rheometer, and intended to hide a portion of the book (e.g., characters).

In particular, the organic solvent may be a halogenated hydrocarbon, an aliphatic hydrocarbon, such as, for example, a non-halogenated or alkylated cyclohexane, a low molecular weight alcohol or an alkylbenzene. In a particularly advantageous embodiment of the present disclosure, the content of organic solvent of the removable hiding fluid is between 25% and 75% by weight.

The function of this dispersing and wetting agent is to improve the dispersion of the white pigment in the solvent of the removable hiding fluid, and in particular to facilitate the rehomogenization thereof, and therefore the aging over time of the removable hiding fluid.

The removable hiding fluid according to the present invention also include an opacifier. For the purposes of the present invention, “opacifier” means any pigment, in particular white pigment, which makes it possible to give the removable hiding fluid its coverage, that is to say its ability to completely cover and hide a writing mark. In particular, the opacifier is chosen from kaolin, calcium carbonate, titanium oxide and mixtures thereof, in particular from calcium carbonate, titanium oxide and mixtures thereof. It is advantageously titanium oxide (TiO₂) which has a superior opacifying power to kaolin and to calcium carbonate.

The removable hiding fluid according to the second example includes a resin which makes it possible to bind the opacifier to the paper and aids in the formation of a flexible but continuous film which covers what remains of the composition of the removable hiding fluid once the solvent has evaporated. This resin is therefore advantageously a film-forming polymeric material. Advantageously, the resin is chosen from vinyl chloride polymers, acrylic resins and vinyl chloride/vinyl ether copolymers.

In particular, it is an acrylic resin, more advantageously a vinyl acrylate copolymer, even more advantageously a styrene acrylate copolymer. More particularly, this resin may be sold by Omnova solutions under the name PLIOWAY® EC1. In an advantageous embodiment of the present invention, the content of resin d) in the removable hiding fluid according to the second example is between 5 and 15% by weight, advantageously between 8 and 10% by weight, relative to the total weight of the removable hiding fluid.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A removable hiding fluid capable of being removed from a paper after being applied and solidified on the paper, wherein the removable hiding fluid includes an additive that allows the removable hiding fluid to be peeled off from the paper.

2. The removable hiding fluid according to claim 1, wherein the additive is a melted rubber having a content between 0.01% and 10% by weight relative to a total weight of the removable hiding fluid.

3. The removable hiding fluid according to claim 1, wherein the rubber element is a silicone rubber.

4. A removable hiding fluid comprising:
an organic solvent;
a dispersing and wetting agent having a polyamine amide of polycarboxylic acid;
an opacifier at a content between 50% and 60% by weight relative to a total weight of the removable hiding fluid;
a resin; and
an additive including a rubber element melted into a mixture of the organic solvent, dispersing and wetting agent, specifier and resin.

5. The removable hiding fluid according to claim 4, wherein content of the melted rubber in the additive is between 0.01% and 10% by weight relative to the total weight of the removable hiding fluid.

6. The removable hiding fluid according to claim 4, wherein the rubber element is a silicone rubber.

7. The removable hiding fluid according to claim 4, wherein the additive further includes at least one of optical brighteners, wetting agents, fillers, a tint-modifying pigment, plasticizes, surfactants, rheological additives and mixtures thereof.

8. The removable hiding fluid according to claim 4, wherein the organic solvent is chosen from aliphatic hydrocarbons.

9. The removable hiding fluid according to claim 4, wherein a content of the organic solvent is between 25% and 75% by weight relative to the total weight of the removable hiding fluid.

10. The removable hiding fluid according to claim 4, wherein the opacifier is TiO₂.

11. The removable hiding fluid according to claim 4, wherein a content of the opacifier is between 40% and 60% by weight relative to the total weight of the removable hiding fluid.
